(19) United States
(12) Patent Application Publication
(10) Pub. No.: US 2003/0033679 A1
(43) Pub. Date: Feb. 20, 2003

(54) Brush section for an electric toothbrush

(76) Inventors: Joseph Fattori, Mendham, NJ (US); Hui Fung Kut, Hong Kong (HK)

Correspondence Address: COLGATE-PALMOLIVE COMPANY, 909 RIVER ROAD, PISCATAWAY, NJ, 08855, US

(21) Appl. No.: 09/682,312

(22) Filed: Aug. 17, 2001

(51) Int. Cl. A61C 17/34

(52) U.S. Cl. 15/22.1; 15/28

(57) ABSTRACT

An electric toothbrush head section and method of manufacture thereof, which head section contains a movable and at least one static bristle bearing components, wherein the static bristle bearing component is interfitted about the exterior of said head section, in a fashion to reduce the seepage of liquid therein.

### FIELD OF THE INVENTION

This invention pertains to a brush section for an electric toothbrush and a method of manufacture thereof, and more particularly to such a section having a housing with a moving bristle bearing component and at least one static bristle bearing component mounted thereon, wherein the static bristle bearing component is held in interfitting engagement about the exterior of said housing.

### BACKGROUND OF THE INVENTION

The benefits of brushing one's teeth using toothbrushes are well known, and motorized movement in toothbrushes has been the subject of much recent innovation and design activity. The commercial market has seen the introduction, over the last several years, of many different types of motorized toothbrushes. However, an examination of the available published literature describing this technology shows a tendency towards increasingly complex, expensive, and noncommercially feasible methods of achieving motorized motions in the bristles and heads of toothbrushes to aid in more effective cleaning of teeth.

The commercial marketplace has been divided into tiered price markets. At the higher priced end are complex motorized toothbrushes that provide various motions to the bristles and brush head, which brush heads are replaceable when the bristles become worn. Intermediate priced brushes, which are still relatively expensive for the mass market, provide simpler designs than the more complex higher end toothbrushes and generally still provide replaceable head sections. The lower priced end of the market includes brushes that only vibrate through the use of an offset weight attached to the motor shaft and which provide little true additional cleaning benefit since no vigorous motion is transmitted to the cleaning surface of the teeth; and simplified designed brushes which have generally fixed non-replaceable head sections, having the obvious disadvantage that when the bristles become worn the toothbrush must be replaced.

U.S. Pat. Nos. 6,000,083 and 6,178,579 disclose low priced electric toothbrushes, wherein the brush head includes a circular moving bristle component preferably located at the end of the brush head distal to the brush handle and adjacent to which circular moving component is a static bristle component. The circular moving bristle component is disclosed as containing stiffer bristles to aid in the deep cleaning and plaque removal process further back in the user's mouth; while the static bristle component contains softer bristles, so as not to damage the gums. This combination of moving and static bristles provides the user with a more traditional, larger brush head than other electric brushes, which merely contain circular bristle bearing heads; which larger brush head permits the user to brush his teeth in the typical manner of an up and down fashion. However, as disclosed within 6,000,083 and 6,178,579, the static bristle component is integrally molded as part of the overall housing of the toothbrush. This integral configuration of the static bristle component with the housing makes for inefficient tufting of the static bristle component, as the housing component containing the static bristle component must itself be manipulated into a tufter and leads to inefficiencies when a new design static bristle pattern is desired, as the entire mold of the housing component containing the static bristle component must be replaced.

U.S. Pat. No. 5,186,627 discloses a non-powered toothbrush having a combination of a rotatable and fixed brush sections, wherein the fixed brush section is in snap-fit engagement internal to the outer cover of the toothbrush. Such a configuration, with the fixed brush section being retained within a surrounding cover, will allow seepage into the brush head and the accumulation of liquid therein, which may promote the undesired growth of bacteria and mold therein.

There is thus a need in the art for a design for an electric toothbrush head section which contains a combination of a movable and static bristles, wherein the static bristle component is not integral with the housing of the brush head section, such that the static bristle component can be efficiently tufted; such that a new design for the static component's bristle pattern can be implemented without replacing the mold for the overall head section in which the static bristle component is contained; and such that seepage into the brush head is reduced to avoid the undesired growth of bacteria and mold therein.

### SUMMARY OF INVENTION

The present invention is directed to an electric toothbrush head section containing a housing on which is mounted a moving bristle bearing component and at least one static, i.e. fixed or non-movable, bristle bearing component and to a method of manufacture thereof, wherein the static bristle bearing component is mounted so as to at least partially surround the exterior the housing. In a preferred embodiment, the moving bristle bearing component is circular in cross-section and the static bristle component is u-shaped, wherein the sides of the “u” are permanently, mechanically interfitted about the exterior of the housing. The relatively small size and u-shaped configuration of the static bristle bearing component provides for ease of manipulation thereof, as it is manufactured and tufted. Further, the u-shape provides for an overlap of the static bristle bearing component about the exterior of the housing upon which it is mounted, to reduce seepage of liquid into the head section, to reduce the undesirable growth of bacteria and mold therein.

The preferred circular bristle bearing component is located adjacent the front end of the head section, distal from the handle of the electric toothbrush from which said head section extends. The preferred circular bristle bearing component may rotate, swivel, gyrate, oscillate or reciprocate about an axis substantially normal to the longitudinal axis of the head section. The static bristle component or components may be located adjacent to the circular bristle bearing component and on one or more sides thereof.

### BRIEF DESCRIPTION OF DRAWINGS

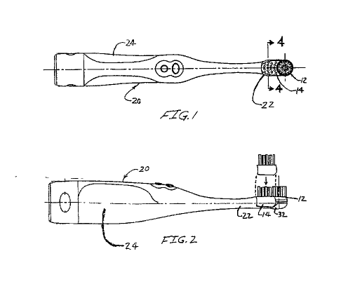

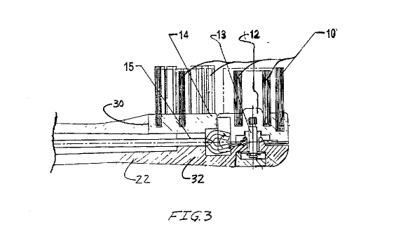

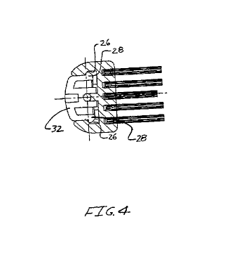

The ensuing description of the invention will be understood more readily from the accompanying drawings, in which: FIG. 1 is front view of an electric toothbrush containing a head section of the present invention having a circular bristle bearing component and a static bristle bearing component; FIG. 2 is side elevation view of the electric toothbrush of FIG. 1; FIG. 3 is fragmentary sectional view of the side of the head section of the electric toothbrush of FIG. 1; FIG. 4 is a sectional view of FIG. 1 along line 4-4, showing a preferred embodiment of the present invention, wherein the u-shaped static bristle bearing component is mechanically held in interfitting engagement with the brush head section by a rib and groove closure.

### DETAILED DESCRIPTION

Referring to FIGS. 1 and 3, which respectively illustrate, an elongated electric toothbrush 20 having at its first end a handle 24 and the details of a head section 22 of the present invention. As shown in FIG. 3, said head section 22 with a drive shaft 15 running longitudinally therethrough, contains a housing 32; which housing 32 has mounted thereon a combination of a fixed, non-movable bristle bearing component 14 and a movable bristle bearing component 12. Which drive shaft 15 is drivably coupled on one end to said movable bristle bearing component 12 and on the other end to a motor located in said handle 24. The static bristle bearing component 14 is preferably u-shaped and is mounted on and about the exterior of said housing 32 in an inverted position, such that said housing 32 is at least partially surrounded on three sides by the inverted “u”. The inverted “u” is preferably secured in place by an interfitting closure about the exterior of said housing 32. The interfitted closure is preferably a permanent closure, to avoid the possibility of the static bristle component 14 becoming loose during usage and being swallowed by or choking the user.

The head section 22 of the present invention, as shown in FIG. 1, is integrally attached, i.e. permanently attached, to the balance of the electric toothbrush handle 24. However, as is well known in the art, the present invention can alternatively be used in conjunction with a head section 22 which is demountably attached, i.e. temporarily attached, to the balance of the electric toothbrush handle 24.

FIG. 2 is a side elevation view of the electric toothbrush 20 of FIG. 1, wherein the preferred u-shaped static bristle bearing component 14 of the present invention is shown in two positions, a first position as a tufted component aligned as an inverted “u” above the housing 32, which tufted component is then interfitted about the exterior of the housing 32 mechanically, as shown by the arrow; whereby it assumes the second position as part of the completed toothbrush 20. The relatively small size of the static bristle bearing component 14 (as shown), in combination with its u-shape, allow easy manipulation of multiple static bristle bearing components, such that such multiple components can be simultaneously pre-tufted in an efficient manner.

Referring again to FIG. 3, the movable bristle bearing component 12, is preferably circular in cross-section, as shown with bristle tufts 10 extending therefrom. The movable bristle bearing component 12 is movably supported by an axis 13; and is motivated by said drive shaft 15, a preferred motivation means as disclosed in U.S. Pat. No. 5,625,916. The movable bristle bearing component may be driven so as to rotate, swivel, gyrate, oscillate or reciprocate about an axis substantially normal to the longitudinal axis of the head section.

In the present invention, the movable bristle bearing component 12 is in combination with a static bristle bearing component 14, each component having bristle tufts 10 also extending therefrom. This combination of a movable bristle bearing component 12 and a static bristle bearing component 14, is preferably configured as shown in FIGS. 1, 2, and 3, wherein the movable bristle bearing component 12 is located adjacent the front end of the head section 22, i.e. distal from the handle 24, and the static bristle bearing component 14 located immediately adjacent thereto. The static bristle bearing component 14 may alternatively be located adjacent the front end of the head section 22 and the movable bristle bearing component 12 located adjacent thereto and more proximate to the handle 24, as shown in U.S. Pat. No. 6,178,579 and 6,189,693. Further, the movable bristle bearing component 12 may be located more centrally within the head, with the static bristle bearing component 14 located on opposite sides of the head with respect thereto, as shown in U.S. Pat. Nos. 5,186,627 and 6,000,083.

FIG. 4, a sectional view of the head section of the present invention looking along section 4-4 of FIG. 1, shows a preferred interfitting rib 28 and groove 26 configuration for permanently attaching the static bristle bearing component 14 about the exterior of the housing 32 of the head section 22. The rib may be carried by the housing 32, as shown, or by the static bristle bearing component 14. To hold the static bristle bearing component 14 securely in position along the longitudinal axis of the head section 22, a retaining wall 30 is provided extending transverse to the longitudinal axis of the brush head 22 on the side of the static bristle bearing component 14 adjacent to the handle 24; and a pair of extending flanges (not shown) are provided which extend on each side of the head section 22 at the other, i.e. front end, of the static bristle bearing component located distal from the handle 24. The pair of extending flanges are positioned to seat against the front end of the static bristle bearing component 14; while, the other end of the static bristle bearing component 14 seats against the retaining wall 30, such that the static bristle bearing component 14 is held securely between the pair of extending flanges and the retaining wall 30.

In other embodiments, the static bristle bearing component 14 may be held about the housing 32 by other known male/female interfitting means which lock into a permanently secured arrangement, or by being permanently welded thereon. Such welding can be by ultrasonic, laser, hot air or other known techniques, which while more costly than a mechanical interfitting closure, may provide the additional benefit of further reducing seepage of liquid into the toothbrush head section 22. Further, the joining of the static bristle bearing component 14 to the housing 32 may be by use of an adhesive bond therebetween.

The static bristle bearing component 14, and the housing 32 of the head section 22 of the present invention can be molded of a variety of flexible resilient plastic materials, such as polyamide, i.e. nylon; polyester or a co-polyester; acrylonitrile butadiene styrene (ABS); polycyclohexylene dimethylene terphthalate that is acid modified (PCTA); or polypropylene; preferably polyproplyene; or, if a transparent appearance is desired of polyester. A preferred polypropylene is available from Montell North America, Inc., of Wilmington, Del., sold under the trade-designation PP6331. Other suitable polypropylenes include those available from Amoco Polymers, Inc., Alpharetta, Ga. 30202-3914, sold under the trade-designation 7635 and from Huntsman Corporation, Longview, Tex. 75603, under the trade-designation Huntsman Polypropylene P4G3Z-039.

What is claimed is:

1. An electric toothbrush head section (22) comprising a housing (32) on which is mounted a movable bristle bearing component (12) and at least one static bristle bearing component (14), wherein the static bristle bearing component (14) is mounted on said housing (32) so as to at least partially surround the exterior thereof.

2. The electric toothbrush head section (22) of claim 1, where said movable bristle bearing component has a circular cross-section.

3. The electric toothbrush head section (22) of claim 1, wherein the static bristle bearing component (14) is u-shaped.

4. The electric toothbrush head section (22) of claim 1, wherein the static bristle bearing component (14) is secured by interfitting means about said housing (32).

5. The electric toothbrush head section (22) of claim 4, wherein said interfitting means is comprised of an interlocking rib and groove.

6. The electric toothbrush head section (22) of claim 1, wherein the at least one static bristle bearing component (14) is secured by welding means.

7. A method of manufacture of an electric toothbrush head section (22) having a housing (32) and a movable bristle bearing component (12) comprising providing at least one static bristle bearing component (14) and interfitting said at least one static bristle bearing component about the exterior of said housing (32), whereby said at least one static bristle bearing component (14) partially surrounds the exterior of said housing (32) in a manner to reduce seepage of liquid therein during use thereof.

8. The method of manufacture of an electric toothbrush head section (22) of claim 7, wherein said movable bristle bearing component (12) is circular in cross-section.

9. The method of manufacture of an electric toothbrush head section (22) of claim 7, wherein the static bristle bearing component (14) is u-shaped.

10. The method of manufacture of an electric toothbrush head section (22) of claim 7, wherein the static bristle bearing component (14) is secured about said housing (34) by interfitting means.

11. The method of manufacture of an electric toothbrush head section (22) of claim 10, wherein said interfitting means is comprised of an interlocking rib and groove.

12. The method of manufacture of an electric toothbrush head section (22) of claim 7, wherein the static bristle bearing component (14) is secured about said housing (32) by welding means.
